(19) United States
(12) Patent Application Publication
(10) Pub. No.: US 2021/0192751 A1
(43) Pub. Date: Jun. 24, 2021

(54) DEVICE AND METHOD FOR GENERATING IMAGE

(71) Applicant: Sung Uk HAN, Busan (KR)

(72) Inventor: Sung Uk HAN, Busan (KR)

(21) Appl. No.: 17/273,435

(22) PCT Filed: Aug. 7, 2019
(86) PCT No.: PCT/KR2019/009869

§ 371 Date: Mar. 4, 2021

(30) Foreign Application Priority Data
Sep. 10, 2018 (KR) 10-2018-0107839

(51) Int. Cl. G06T 7/215; G06T 5/50; H04N 5/232

(52) U.S. Cl. CPC G06T 7/215; G06T 2207/10004; H04N 5/23254; G06T 5/50

(57) ABSTRACT

Disclosed are a device and a method for generating an image. That is, the present invention automatically identifies and removes moving objects in a plurality of consecutive images including one or more objects captured at the same location, thereby generating an image including only a desired object of which movement is maintained. As such, even when an image is captured in a crowded place, such as a tourist destination, an image including only a desired object may be obtained, thereby increasing the user's interest.

### TECHNICAL FIELD

The present invention relates to an image generation device and a method thereof, and particularly to, an image generation device and method which automatically identify and remove a moving object from a plurality of consecutive images including one or more objects, captured in the same position, generating an image including only desired objects whose movement is maintained.

### BACKGROUND ART

In general, a mobile terminal is a device that performs a global positioning system (GPS) function and a call function and provides its results to the user.

In addition to the voice call and text transmission service, the mobile terminal may easily take a desired image anytime, anywhere by a portable camera equipped therein, and may support various functions, such as image information transmission and video call. Video call-capable mobile terminals are divided into a camera built-in type with a built-in camera and a camera-attached type in which a separate camera is plugged into the main body of the mobile terminal.

Such a mobile terminal only provides simple functions, such as fetching and displaying captured images or providing a simple editing function for the user's convenience.

Further, upon taking a picture using a mobile terminal in, e.g., a famous tourist spot, the user may not obtain his desired photo because other people or objects moving around the user may be taken together.

### DETAILED DESCRIPTION OF INVENTION

### Technical Problems

An object of the present invention is to provide an image generation device and method that automatically identifies and removes a moving object from a plurality of consecutive images including one or more objects captured in the same location, thereby generating an image including only a desired object whose movement is maintained.

### Means to Address Problems

According to an embodiment of the present invention, an image generation device may comprise a camera unit obtaining a plurality of original images, a controller generating a plurality of images which are copied images of the plurality of original images obtained by the camera unit, recognizing one or more objects included in the plurality of images, identifying coordinates and distances between objects recognized in each of the plurality of images, identifying at least one object without movement and at least one object with movement among the objects included in the images by identifying the coordinates and distances between the objects in two consecutive images of the plurality of images, identifying a first area related to the at least one object with movement in a reference image, deleting the first area related to the at least one object with movement identified in the reference image, deleting an area related to the at least one object with movement present in the first area in remaining images except for the reference image among the plurality of images, generating a first replacement image corresponding to an image, in which the at least one object with movement is deleted in the first area, by synthesizing the first area in the remaining images in which the area related to the at least one object with movement is deleted, and generating a new image by synthesizing the generated first replacement image to the deleted first image in the reference image, and a display unit displaying the generated new image.

As an example related to the present invention, the first replacement image may include coordinate information corresponding to the first area, and a size and shape of the first replacement image may correspond to a size and shape of the first area.

As an example related to the present invention, the controller may generate the new image by synthesizing the first replacement image to the deleted first area in the reference image based on coordinate information corresponding to the first area included in the first replacement image.

As an example related to the present invention, the controller may identify a second area related to the at least one object with movement for the plurality of images, delete an area related to the at least one object with movement present in the identified second area in the plurality of images, generate a second replacement image corresponding to the image, in which the at least one object with movement is deleted in the second area by synthesizing the second area in the plurality of images where the area related to the at least one object with movement is deleted, delete the second area in a reference image, and generate the new image by synthesizing the generated second replacement image to the deleted second area in the reference image.

According to an embodiment of the present invention, an image generation method may comprise obtaining a plurality of original images by a camera unit, generating, by a controller, a plurality of images which are copied images of the plurality of original images obtained by the camera unit, recognizing, by the controller, each of one or more objects included in the plurality of images, identifying, by the controller, coordinates and distances between objects recognized in each of the plurality of images, identifying, by the controller, at least one object without movement and at least one object with movement among the objects included in the images by identifying the coordinates and distances between the objects in two consecutive images of the plurality of images, identifying, by the controller, a second area related to the at least one object with movement for the plurality of images, deleting, by the controller, an area related to the at least one object with movement present in the identified second area in the plurality of images, generating, by the controller, a second replacement image corresponding to an image in which the at least one object with movement is deleted in the second area by synthesizing the second area in the plurality of images, in which the area related to the at least one object with movement is deleted, generating, by the controller, a new image by deleting the second area in the reference image and synthesizing the generated second replacement image to the deleted second area in the reference image, and controlling, by the controller, a display unit to display the generated new image.

As an example related to the present invention, the image generation method may further comprise identifying, by the controller, a first area related to the at least one object with movement in the reference image, deleting, by the controller, the first area related to the at least one object with movement identified in the reference image and deleting an area related to the at least one object with movement present in the first area in remaining images except for the reference image among the plurality of images, generating, by the controller, a first replacement image corresponding to an image in which the at least one object with movement is deleted in the first area by synthesizing the first area in the remaining images, in which the area related to the at least one object with movement is deleted, and generating, by the controller, the new image by synthesizing the generated first replacement image to the deleted first area in the reference image.

As an example related to the present invention, the image generation method may further comprise performing an edit function on the new image displayed on the display unit according to a user input, by the controller, when a preset edit menu displayed on a side of the display unit is selected, and displaying a result of performing the edit function by the display unit.

As an example related to the present invention, performing the edit function on the new image may include at least one of, when any one of objects included in the new image displayed on the display unit is selected, identifying, by the controller, a third area related to the selected object in the new image, deleting, by the controller, the third area related to the identified object in the new image, generating, by the controller, another new image by replacing the third area in the new image, in which the third area is deleted, with a surrounding color of the third area, generating, by the controller, the other new image by deleting an area related to the any one object present in the identified third area in the plurality of images, for the plurality of images, synthesizing the third area in the plurality of images in which the area related to the any one object is deleted to thereby generate a third replacement image corresponding to the image in which the any one object is deleted in the third area, and synthesizing the generated third replacement image to the deleted third area in the new image, generating, by the controller, the other new image by copying and pasting a specific part of the new image according to a user selection, to the deleted third area in the new image, and generating, by the controller, the other new image by pasting another image according to a user selection to the deleted third area in the new image.

### Effects of Invention

The present invention automatically identifies and removes a moving object from a plurality of consecutive images including one or more objects captured in the same location, thereby generating an image including only the desired object whose movement is maintained. Therefore, even when an image is captured in a crowded place, an image including only a desired object may be acquired, thereby increasing the user's interest.

### BRIEF DESCRIPTION OF THE DRAWINGS

FIG. 1 is a block diagram illustrating a configuration of an image generation device according to an embodiment of the present invention;

FIGS. 2 and 3 are flowcharts illustrating an image generation method according to an embodiment of the present invention; and

FIGS. 4 to 19 are views illustrating images generated according to an embodiment of the present invention.

### BEST MODE TO PRACTICE THE INVENTION

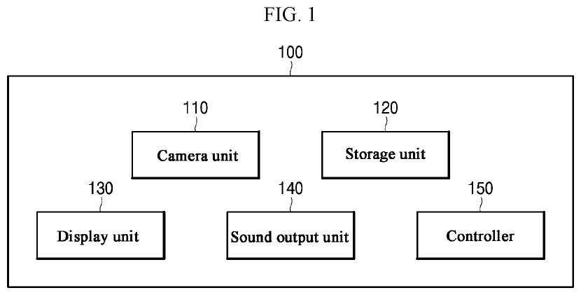

FIG. 1 is a block diagram illustrating a configuration of an image generation device 100 according to an embodiment of the present invention.

As illustrated in FIG. 1, the image generation device 100 includes a camera unit 110, a storage unit 120, a display unit 130, a sound output unit 140, and a controller 150. All of the components of the image generation device 100 shown in FIG. 1 are not essential components, and the image generation device 100 may be implemented with more or less components than those shown in FIG. 1.

The image generation device 100 may be applicable to various terminals or devices, such as smartphones, portable terminals, mobile terminals, personal digital assistants (PDAs), portable multimedia players (PMPs), telematics terminals, navigation terminals, personal computers, laptop computers, slate PCs, tablet PCs, Ultrabook computers, wearable devices, such as smartwatches, smart glasses, head-mounted displays, etc., Wibro terminals, Internet protocol television (IPTV) terminals, smart TVs, digital broadcast terminals, audio video navigation (AVN) terminals, audio/video (A/V) systems, flexible terminals, or digital signage devices.

Further, the image generation device 100 may further include a communication unit (not shown) for communication connection with an internal component or at least one external terminal through a wired/wireless communication network.

The camera unit 110 processes image frames, such as still images or moving pictures obtained by an image sensor (camera module or camera) in a video call mode, a recording mode, or a video conference mode. That is, the image data obtained by the image sensor is encoded/decoded to meet each standard according to the codec. The processed image frames may be displayed on the display unit 130 under the control of the controller 150. As an example, the camera may capture an object (or subject) (e.g., a product or user) and output a video signal corresponding to the captured image (an image of the object).

Further, the image frame processed by the camera unit 110 may be stored in the storage unit 120 or transmitted to the server or another terminal through the communication unit.

The camera unit 110 may provide a panoramic image (or panoramic image information) obtained (or captured) via a 360-degree camera (not shown) to the controller 150. The 360-degree camera may capture panoramic images or videos in two dimension (2D) or three dimension (3D). As used herein, the term “image” may encompass videos, but not only still images.

When a preset button formed on one side of the image generation device 100 is clicked (or touched/selected), or a preset capturing menu (or capturing item) displayed on one side of the display unit 130 is selected (or touched/clicked), the camera unit 110 acquires (or captures) a plurality of original images using a continuous capturing function (or continuous shooting function) at preset time intervals.

In an embodiment of the present invention, it is described that the plurality of original images are acquired by the continuous shooting function included in the camera unit 110, but the present invention is not limited thereto, and the plurality of original images may be ones obtained by the normal capturing function.

Further, the camera unit 110 may obtain the plurality of original images by performing the capturing function at preset time intervals for a preset capturing time (e.g., 10 seconds).

When a plurality of original images are obtained by the normal capturing function, the plurality of original images may have been captured with different focuses (or multi-focusing). Thus, the plurality of original images may be partially corrected (or modified/edited) through image correction (or image interpolation), with a focus being on a specific object included in the plurality of original images.

That is, the camera unit 110 may perform multi-focusing (or multi-focusing) from the beginning, obtaining an original image including a plurality of objects according to multi-focusing.

The camera unit 110 may add the user's additional focusing to the multi-focusing according to the user's control (or user's selection/touch), thus obtaining an original image including a thing (or person) related to the area to be focused by the user.

For example, when a specific object (e.g., including the Eiffel Tower or a statue) temporarily displayed on the screen is selected in a multi-focusing state for a plurality of users, the camera unit 110 may also focus on the selected specific object and, in that state, obtain original images for the plurality of users and the specific object.

Further, the camera unit 110 may apply an automatic correction function to a minute difference that may have occurred due to an error even when the hand of the person taking a picture slightly shakes or moves.

The storage unit 120 stores various user interfaces (UIs) and graphic user interfaces (GUIs).

The storage unit 120 stores a program and data necessary for the image generation device 100 to operate.

That is, the storage unit 120 may store a plurality of application programs (or applications) which may run on the image generation device 100 and data and instructions or commands for operations of the image generation device 100. At least some of the application programs may be downloaded from an external server via wireless communication. Further, at least some of these application programs may exist on the image generation device 100 from the time of shipment for basic functions of the image generation device 100. Meanwhile, the application program may be stored in the storage unit 120, installed on the image generation device 100, and driven by the controller 150 to perform operations (or functions) of the image generation device 100.

The storage unit 120 may include at least one type of storage medium of flash memory types, hard disk types, multimedia card micro types, card types of memories (e.g., SD or XD memory cards), RAMs (Random Access Memories), SRAMs (Static Random Access Memories), ROMs (Read-Only Memories), EEPROMs (Electrically Erasable Programmable Read-Only Memories), PROMs (Programmable Read-Only Memories), magnetic memories, magnetic disks, or optical discs. The image generation device 100 may operate web storage which performs the storage function of the storage unit 120 over the Internet or may operate in association with the web storage.

Further, the storage unit 120 stores images (including, e.g., still images or videos) captured (or acquired) through the camera unit 110.

The display unit 130 may display various contents, e.g., various menu screens, using the UI and/or GUI stored in the storage unit 120 under the control of the controller 150. The contents displayed on the display unit 130 include a menu screen including various pieces of text or image data (including various information data), icons, a list menu, combo boxes, or other various pieces of data. The display unit 130 may be a touchscreen.

The display unit 130 may include at least one of a liquid crystal display (LCD), a thin film transistor-liquid crystal display (TFT-LCD), an organic light-emitting diode (OLED), a flexible display, or a three-dimensional (3D) display, an e-ink display, or a light emitting diode (LED) display.

Further, the display unit 130 displays images (including, e.g., still images or videos) captured (or acquired) through the camera unit 110 under the control of the controller 150.

The sound output unit 140 outputs voice information included in a signal signal-processed by the controller 150. The sound output unit 140 may include, e.g., a receiver, a speaker, and a buzzer.

The sound output unit 140 outputs a guidance voice generated by the controller 150.

Further, the sound output unit 140 outputs voice information (or sound effect) corresponding to an image (e.g., including a still image or a video) captured (or acquired) through the camera unit 110 by the controller 150.

The controller (or microcontroller unit (MCU)) 150 executes an overall control function of the image generation device 100.

Further, the controller 150 executes an overall control function of the image generation device 100 using programs and data stored in the storage unit 120. The controller 150 may include a RAM, a ROM, a central processing unit (CPU), a graphics processing unit (GPU), and a bus, and the RAM, ROM, CPU, and GPU may be interconnected via the bus. The CPU may access the storage unit 120 and boot the operating system (OS) stored in the storage unit 120. The CPU may perform various operations using various programs, contents, and data stored in the storage unit 120.

Further, the controller 150 stores a plurality of original images, which are the acquired originals, in the storage unit 120, and generates a plurality of images (or a plurality of copied images) that are copies of the plurality of original images. In this case, the controller 150 sets a first image among the plurality of images as a reference image. Here, the controller 150 may set a specific image, placed in a specific position or selected by the user among the plurality of images, as a reference image.

Further, the controller 150 recognizes each of one or more objects included in the plurality of images. In recognizing an object in the image, one or more of various known object recognition methods may be used. In this case, the object includes a person or thing (e.g., a building, vehicle, or mountain).

Further, in the case of recognizing one or more objects included in the plurality of images, the controller 150 may recognize one or more objects located within a preset radius around the focused area when acquiring the image through the camera unit 110. Accordingly, the process of recognizing fixed buildings, trees, mountains, etc. in the image is omitted, thereby reducing the object recognition time and enhancing system efficiency.

Further, the controller 150 identifies (or calculates) distances and coordinates between objects recognized in the plurality of images. Here, the coordinates may be relative coordinates based on a preset reference position (or reference coordinates) for the image (e.g., a lower left corner of the image).

Further, the controller 150 identifies (or determines) at least one non-moved object and at least one moved object among the objects included in the images through identification (or comparison) of the distance and coordinates between objects in two consecutive images among the plurality of images.

That is, the controller 150 compares the distances and coordinates between objects identified in each of the continuous images among the plurality of images, thereby identifying at least one non-moved object and at least one moved object among one or more objects included in the consecutive images.

Further, the controller 150 identifies (or sets) a first area (or coordinates) related to at least one moved or non-moved object in the reference image. In this case, the first area related to the moving object may be in the shape of a rectangle, circle, oval, or triangle to include the moving object and may further include (or expand) a preset number of pixels from the outline (or contour) of the object to include the moving object.

Further, the controller 150 may identify a second area related to at least one moving object among the plurality of images. In this case, the second area may be an area formed by combining all of the coordinates of individual areas including at least one moving object among the plurality of images.

As such, the controller 150 may identify the first area related to at least one moving object based on the reference image, or the second area related to at least one moving object among the plurality of images.

Further, the controller 150 deletes the first area related to at least one identified moving object from the reference image. Further, the controller 150 deletes the area (or sub area) related to at least one moving object present in the first area among the remaining images other than the reference image among the plurality of images.

Further, the controller 150 may delete the area related to at least one moving object from among the other images than the reference image, among the plurality of images.

In this case, the area related to the at least one moving object is deleted from the first area of the remaining images, and the area which is irrelevant to the at least one moving object remains as it is.

Further, the controller 150 may delete the area (or sub area) related to at least one moving object present in the second area identified in the plurality of images.

Further, the controller 150 synthesizes the first areas in the remaining images, where the area related to at least one moving object has been deleted, thereby generating a first replacement image (or first replacement area) corresponding to an image which is in the state where the at least one moving object has been deleted in the first area. Here, the generated first replacement image includes coordinates information corresponding to the first area. Further, the size and shape (or form) of the generated first replacement image corresponds to (or is identical to) the size and shape of the first area. In this case, the controller 150 may perform image correction (or image interpolation) on the first areas in the remaining images.

Further, the controller 150 synthesizes the second areas in the plurality of images, where the area related to at least one moving object has been deleted, thereby generating a second replacement image (or second replacement area) corresponding to an image which is in the state where the at least one moving object has been deleted in the second area. Here, the generated second replacement image includes coordinates information corresponding to the second area. Further, the size and shape (or form) of the generated second replacement image corresponds to (or is identical to) the size and shape of the second area.

Further, the controller 150 synthesizes (or adds) the generated first replacement image (or first replacement area) to the deleted first area in the reference image, generating a new image (or completed image). Here, the controller 150 may synthesize the first replacement image to the deleted first area in the reference image based on coordinate information corresponding to the first area included in the generated first replacement image. In this case, the generated new image may be in a state in which at least one moving object has been deleted from the reference image, and the object-deleted area is replaced with the first replacement image.

Further, the controller 150 may delete the second area from the reference image and synthesize (or add) the generated second replacement image (or second replacement area) to the deleted second area in the reference image, generating a new image (or completed image). Here, the controller 150 may synthesize the second replacement image to the deleted second area in the reference image based on coordinate information corresponding to the second area included in the generated second replacement image.

In this case, if an image that does not include the at least one moving object is among the plurality of images, the controller 150 may generate the first replacement image (or second replacement image) based on the first area (or second area) in the image, which does not include at least one moving object, delete the first area (or second area) from the reference image, synthesize (or add) the generated first replacement image (or second replacement image) to the first area (or second area) deleted in the reference image to thereby generate the new image.

Further, the controller 150 displays the generated new image (or completed image) on the display unit 130.

As such, since moving or walking people, which are captured together with the target by the camera unit 110, move and disappear rather than being shown in the plurality of images, the controller 150 may create a new complete image using the areas which are commonly maintained in the plurality of images.

Thus, the controller 150 may create a new image in which clouds, which are far away, and mountains or buildings, which are used as a background, remain in their fixed positions and target objects for capturing, which remain in the same posture, remain in the photo while passing (or moving/walking) people have disappeared (or deleted).

Further, when a preset edit menu (or edit item) displayed on one side of the display unit 130 is selected, the controller 150 performs an editing function on the new image displayed on the display unit 130 according to the user input (or user selection/control).

That is, when the edit menu (or edit item) displayed on one side of the display unit 130 is selected, the controller 150 operates in an edit mode.

Further, if any one of the objects included in the new image displayed on the display unit 130 is selected according to the user input (or user selection/control), the controller 150 identifies (or sets) a third area (or coordinates) related to the selected object in the new image. Here, the third area related to the selected object may be in the shape of a rectangle, circle, oval, or triangle including the object.

In this case, when a preset event occurs for any one object (or a plurality of objects) among objects included in the new image displayed on the display unit 130 according to the user input (or user selection/control), the controller 150 may identify the third area related to the selected object in the new image. The event includes, e.g., when a preset delete menu item displayed on the display unit 130 is selected after any one object is selected, when a touch (or selection) on any one object lasts for a preset time, or when the user's touch gesture on the image generation device 100 is sensed for any one object. Here, the user's touch gesture on the image generation device 100 includes a tap, touch & hold, double tap, drag, flick, drag and drop, pinch, and swipe.

“Tap” is an action in which the user touches the screen (including objects, place names, or additional information) with a finger or a touching tool (e.g., an electronic pen) and then immediately takes off the screen without moving.

“Touch & hold” is an action in which the user touches the screen (including, e.g., objects, place names, or additional information) with his finger or a touching tool (e.g., an electronic pen) and maintains the touch for a threshold time (e.g., two seconds) or longer. That is, this means a case where the time difference between the touch-in time and the touch-out time is greater than or equal to the threshold time (e.g., 2 seconds). To allow the user to recognize whether the touch input is a tap or a touch & hold, a visual, audible, or tactile feedback signal may be provided when the touch input is maintained for the threshold time or longer. The threshold time may be changed according to an implementation example.

“Double tap” refers to an action in which the user touches the screen twice (including, e.g., an object, place name, or additional information) using his finger or a touch tool (stylus).

“Drag” refers to an action in which the user touches the screen (including objects, place names, or additional information) with his finger or touching tool and then moves the finger or touching tool to another position on the screen while maintaining the touch. By dragging, the object may be moved or a panning operation to be described below may be performed.

“Flick” refers to an action in which the user touches the screen (e.g., object, place name, or additional information) with his finger or a touching tool and then drags it at a threshold speed (e.g., 100 pixels/s) or quicker using the finger or touching tool. A drag (or panning) and a flick may be distinguished based on whether the moving speed of the finger or the touching tool is greater than or equal to the threshold speed (e.g., 100 pixel/s).

“Drag & drop” refers to an action in which the user drags an object (including, e.g., an object, place name, or additional information) to a predetermined position on the screen using his finger or a touch tool and then releases it.

“Pinch” refers to an action in which the user moves his two fingers in different directions while touching the fingers on the screen (e.g., including an object, place name, or additional information).

“Swipe” refers to an action in which the user moves his finger or touching tool to a certain distance in a horizontal or vertical direction while touching an object (including, e.g., an object, place name, or additional information) on the screen with the finger or touching tool. Movement in the diagonal direction may not be recognized as a swipe event.

The event may further include when a tilting of the image generation device 100 in the upper/lower/left/right direction by a predetermined value or more is detected, as a movement of the image generation device 100 sensed by a sensor (not shown) included in the image generation device 100, when a predetermined number of, or more, movements (or shakes/reciprocations) of the image generation device 100 in the upper/lower directions, left/right directions, or diagonal directions are detected, when a predetermined number of, or more, rotations of the image generation device 100 clockwise/counterclockwise are detected, or when the gaze of the user captured by the camera unit 110 (or the user of the image generation device 100) at the selected object is maintained for a predetermined time.

After any one object is selected from among the objects included in the new image displayed on the display unit 130, if the preset edit menu displayed on the display unit 130 is selected, the controller 150 may operate in the edit mode and identify the third area related to any one object selected in the new image.

The controller 150 deletes the third area related to the identified object in the new image. The controller 150 replaces the deleted third area in the new image with the color of the surroundings of the third area (or the any one object), thereby creating another new image.

The controller 150 deletes the third area related to the any one object in the new image. The controller 150 deletes the area (or sub area) related to the any one object present in the third area identified in the plurality of images. Further, the controller 150 synthesizes the third areas in the plurality of images, where the area related to the any one object has been deleted, thereby generating a third replacement image (or third replacement area) corresponding to an image which is in the state where the any one object has been deleted in the third area. Here, the generated third replacement image includes coordinates information corresponding to the third area. Further, the size and shape of the generated third replacement image may be the same as the size and shape of the third area. Further, the controller 150 synthesizes (or adds) the generated third replacement image (or third replacement area) to the deleted third area in the new image, generating another new image (or another completed image). Here, the controller 150 may synthesize the third replacement image to the deleted third area in the new image based on coordinate information corresponding to the third area included in the generated third replacement image. In this case, the other generated new image may be in a state in which the object selected by the user has been deleted from the new image, and the object-deleted area is replaced with the third replacement image.

The controller 150 deletes the third area related to the any one object in the new image. Further, the controller 150 may generate the other new image by copying and pasting, a specific part of the new image according to the user selection, to the deleted third area in the new image.

The controller 150 deletes the third area related to the any one object in the new image. Further, the controller 150 may create the other new image by pasting another image (or emoticon) according to the user selection to the deleted third area in the new image.

Further, the controller 150 displays a result of performing the edit function (or another new image generated according to the execution of the edit function) on the display unit 130.

By such additional edit function, the image generation device 100 may select and delete an object which has a different color from the background color (e.g., a person dressed in black in the blue background of sky or a person dressed in red in a rape flower field and creates another new image by using the color of the surroundings or by copying and pasting another portion as desired, or by synthesizing the replacement image generated according to the corresponding portion.

Further, the image generation device 100 deletes the moving object from the reference image, for the plurality of images obtained by the camera unit 110, generates a replacement image corresponding to the object-deleted area of the reference image, and synthesizes (or adds) the generated replacement image to the object-deleted area of the reference image, thereby creating a new image. The image generation device 100 provides the newly created image to the user. Thus, the user may be provided with photos which focus on the user and the background, with other moving people deleted out, although taken in a crowded place, e.g., tourist spot.

Thus, it is possible to automatically identify and remove a moving object from a plurality of consecutive images including one or more objects captured in the same location, thereby generating an image including only a desired object whose movement is maintained.

The technical configuration according to an embodiment of the present invention may be implemented as an app (or application).

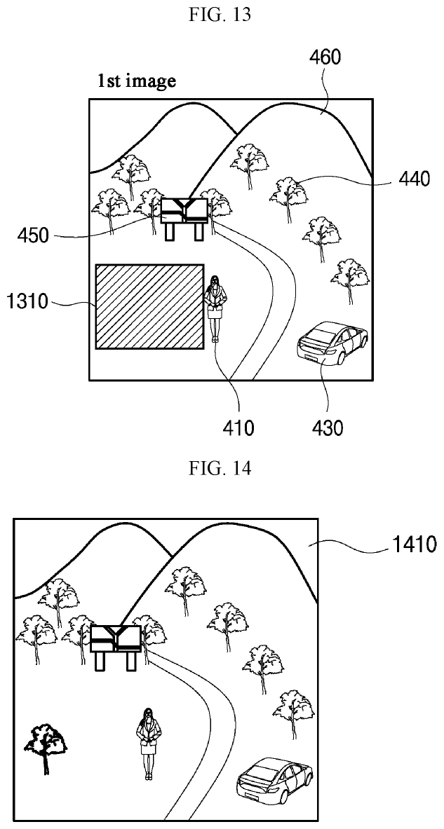

An image generation method according to an embodiment of the present invention is described below in detail with reference to FIGS. 1 to 19.

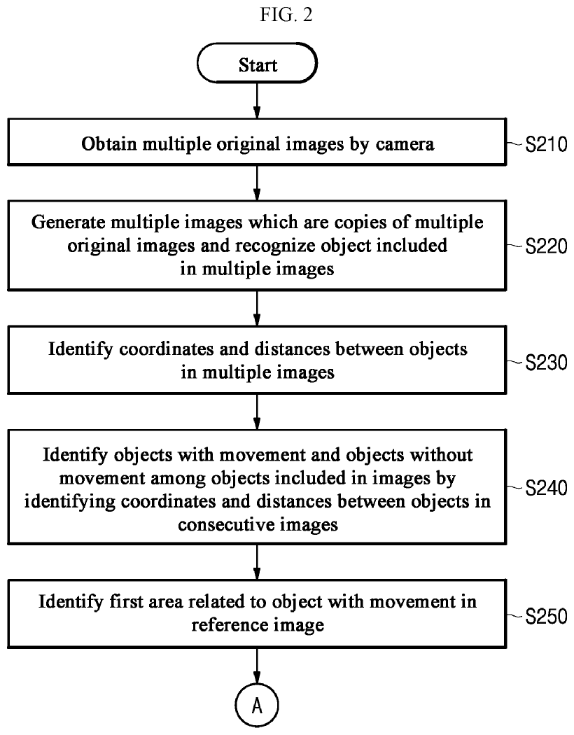

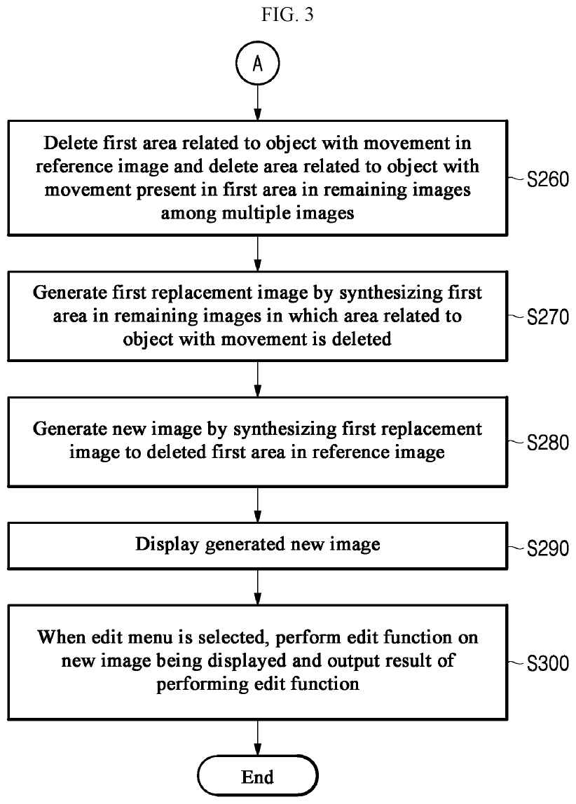

FIGS. 2 and 3 are flowcharts illustrating an image generation method according to an embodiment of the present invention.

When a preset button formed on one side of the image generation device 100 is clicked (or touched/selected), or a preset capturing menu (or capturing item) displayed on one side of the display unit 130 is selected (or touched/clicked), the camera unit 110 acquires (or captures) a plurality of original images using a continuous capturing function (or continuous shooting function) at preset time intervals.

As an example, when a first button formed on one side of the image generation device 100 is clicked, the camera unit 110 obtains 20 original images by continuous shooting at each preset time interval (e.g., an interval of 0.1 seconds) (S210).

Thereafter, the controller 150 stores a plurality of original images, which are the acquired originals, in the storage unit 120, and generates a plurality of images (or a plurality of copied images) that are copies of the plurality of original images. In this case, the controller 150 sets a first image among the plurality of images as a reference image. Here, the controller 150 may set a specific image, placed in a specific position or selected by the user among the plurality of images, as a reference image.

Further, the controller 150 recognizes each of one or more objects included in the plurality of images. In recognizing an object in the image, one or more of various known object recognition methods may be used. In this case, the object includes a person or thing (e.g., a building, vehicle, or mountain).

For example, the controller 150 generates 20 copied images, each of which corresponds to a respective one of the acquired 20 original images, and sets the first acquired (or captured) image among the 20 generated images, as the reference image.

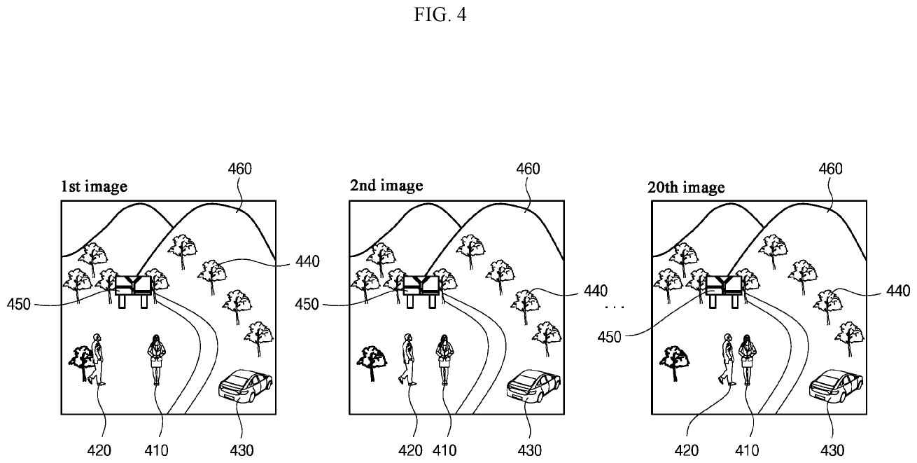

Further, as illustrated in FIG. 4, the controller 150 may recognizes a first user 410, a second user 420, a vehicle 430, a tree 440, a billboard 450, and a building 460 included in the generated 20 images (S220).

Thereafter, the controller 150 identifies (or calculates) distances and coordinates between objects recognized in the plurality of images. Here, the coordinates may be relative coordinates based on a preset reference position (or reference coordinates) for the image (e.g., a lower left corner of the image).

As an example, the controller 150 identifies (or calculates) the coordinates corresponding to the first user 410 and second user 420, the vehicle 430 and tree 440, and the billboard 450 and building 460 recognized in each of the 20 images and the distances between the first user 410 and second user 420 and the vehicle 430 recognized in each image.

In other words, as illustrated in FIG. 4, the controller 150 identifies first-first coordinates corresponding to the first user 410, first-second coordinates corresponding to the second user 420, first-third coordinates corresponding to the vehicle 430, as recognized in the first image among the 20 images, and the first-first distance between the first user and the second user, the first-second distance between the first user and the vehicle, and the first-third distance between the second user and the vehicle in the first image, second-first coordinates corresponding to the first user 410, second-second coordinates corresponding to the second user 420, second-third coordinates corresponding to the vehicle 430, as recognized in the second image among the 20 images, and the second-first distance between the first user and the second user, the second-second distance between the first user and the vehicle, and the second-third distance between the second user and the vehicle in the second image, and third-first coordinates corresponding to the first user 410, third-second coordinates corresponding to the second user 420, third-third coordinates corresponding to the vehicle 430, as recognized in the third image among the 20 images, and the third-first distance between the first user and the second user, the third-second distance between the first user and the vehicle, and the third-third distance between the second user and the vehicle in the third image. As such, the controller 150 identifies the coordinates of each object and inter-object distances in each of the 20 images (S230).

Thereafter, the controller 150 identifies (or determines) at least one non-moved object and at least one moving object among the objects included in the images through identification (or comparison) of the distance and coordinates between objects in two consecutive images among the plurality of images.

That is, the controller 150 compares the distances and coordinates between objects identified in each of the continuous images among the plurality of images, thereby identifying at least one non-moved object and at least one moved object among one or more objects included in the consecutive images.

As an example, as illustrated in FIG. 4, the controller 150 compares the first-first coordinates and second-first coordinates, which are related to the first user, the first-second coordinates and second-second coordinates, which are related to the second user, and the first-third coordinates and second-third coordinates, which are related to the vehicle, the first-first distance and second-first distance, which are related to the distance between the first user and the second user, the first-second distance and second-second distance, which are related to the distance between the first user and the vehicle, and the first-third distance and second-third distance, which are related to the distance between the second user and the vehicle, included in the consecutive, first and second images of the 20 images, thereby identifying the first user 410, vehicle 430, tree 440, billboard 450, and building 460, which remain in fixed positions, and the second user 420 whose position has moved to the right, in the first and second images.

The controller 150 compares the second-first coordinates and third-first coordinates, which are related to the first user, the second-second coordinates and third-second coordinates, which are related to the second user, and the second-third coordinates and third-third coordinates, which are related to the vehicle, the second-first distance and third-first distance, which are related to the distance between the first user and the second user, the second-second distance and third-second distance, which are related to the distance between the first user and the vehicle, and the second-third distance and third-third distance, which are related to the distance between the second user and the vehicle, included in the consecutive, first and second images of the 20 images, thereby identifying the first user 410, vehicle 430, tree 440, billboard 450, and building 460, which remain in fixed positions, and the second user 420 whose position has moved to the right, in the second and third images.

As such, the controller 150 may identify objects which are moved and objects which are not moved in the plurality of images by making comparison as to the coordinates of individual objects and inter-object distances in two consecutive images or a plurality of images for a total of 20 images (S240).

Thereafter, the controller 150 identifies (or sets) a first area (or coordinates) related to at least one moved or non-moved object in the reference image. Here, the first area related to the moved object may be in the shape of a rectangle, circle, oval, or triangle including the moved object.

Further, the controller 150 may identify a second area related to at least one moving object among the plurality of images. In this case, the second area may be an area formed by combining all of the coordinates of individual areas including at least one moving object among the plurality of images.

As such, the controller 150 may identify the first area related to at least one moving object based on the reference image, or the second area related to at least one moving object among the plurality of images.

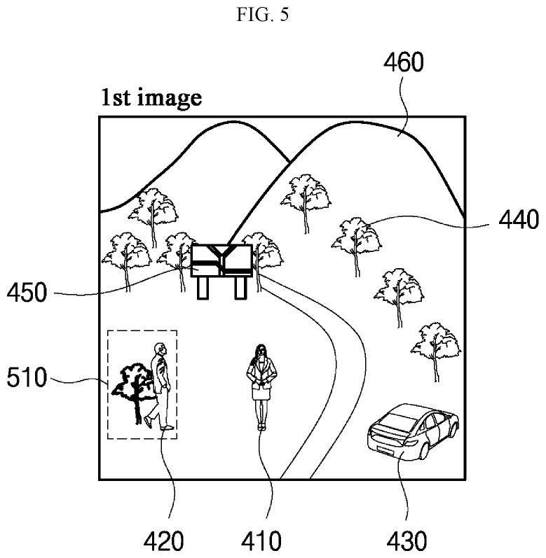

For example, as illustrated in FIG. 5, the controller 150 identifies a first area 510 including a second user who has moved in the first image, which is the reference image.

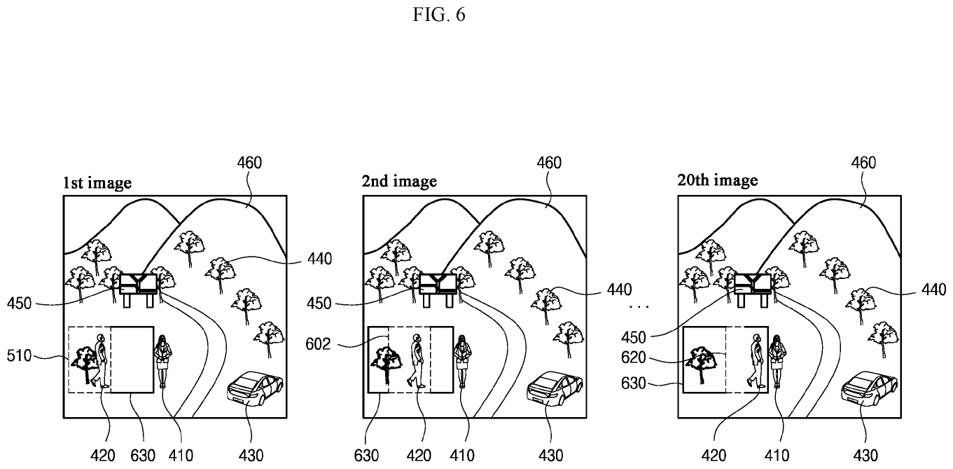

As another example, as illustrated in FIG. 6, the controller 150 identifies a first sub-area 601 to a twentieth sub-area 620 including the second user, who has movement, in the 20 images and combines the first sub-area 601 to twentieth sub-area 620, thereby identifying (or generating) one second area 630 (S250).

Thereafter, the controller 150 deletes the first area related to at least one identified moving object from the reference image. Further, the controller 150 deletes the area (or sub area) related to at least one moving object present in the first area among the remaining images other than the reference image among the plurality of images.

Further, the controller 150 may delete the area related to at least one moving object from among the other images than the reference image, among the plurality of images.

Further, the controller 150 may delete the area (or subarea) related to at least one moving object present in the second area identified in the plurality of images.

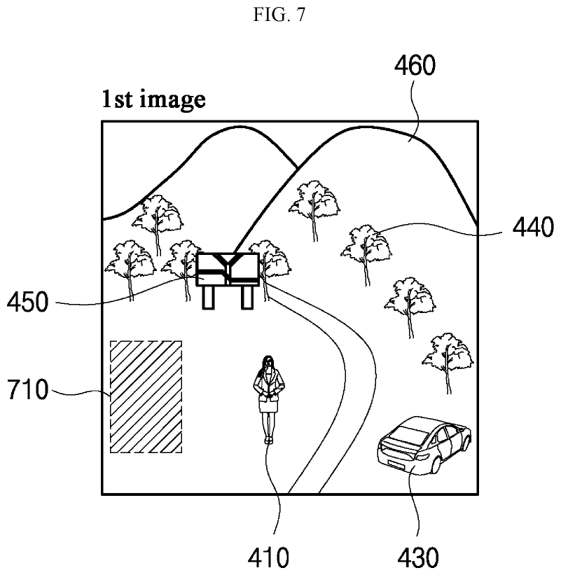

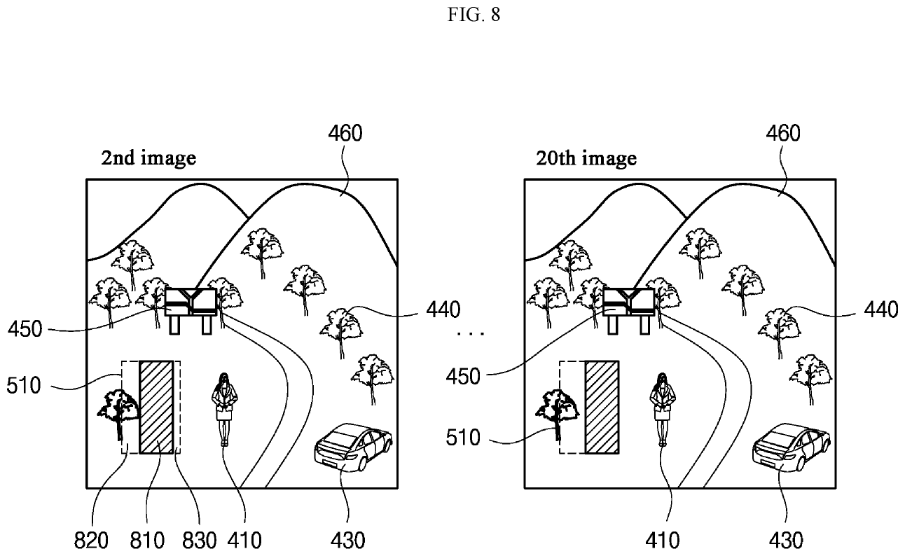

As an example, the controller 150 deletes (shows in hatching) (710) the first area 510 including the second user who has identified movement in the first image which is the reference image as shown in FIG. 5, as shown in FIG. 7. Further, as shown in FIG. 8, the controller 150 deletes the area related to the second user who has movement present in the first area 510 (e.g., the area shown in hatching in FIG. 8) for each of the 20 images or the second image of the 20 images (810). In this case, as shown in FIG. 8, the controller 150 deletes only the area 810 (e.g., the area shown in hatching in FIG. 8) related to the second user who has movement in the first area 510 in the second image to the twentieth image while maintaining the areas (e.g., 820 and 830 of FIG. 8) irrelevant to the second user.

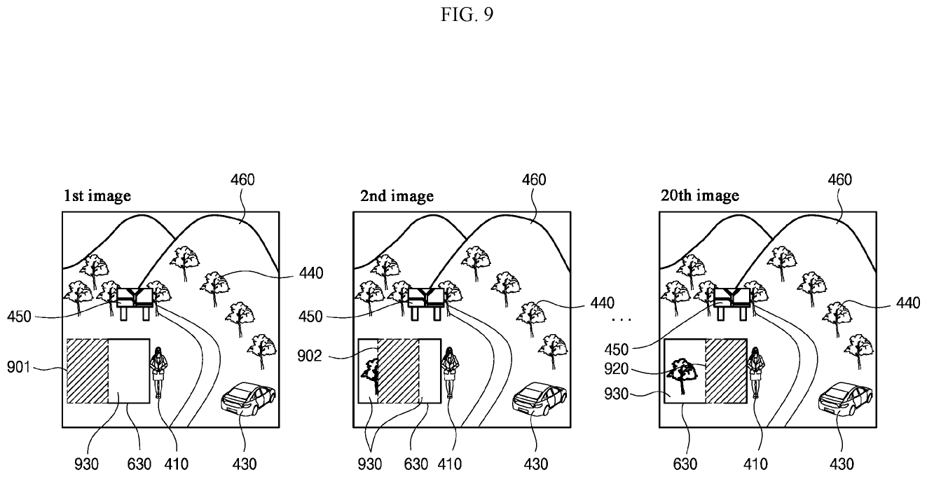

As another example, the controller 150 deletes (901, 903, . . . , 920) the area 601, 602, . . . , 620 related to the second user who has movement present in the second area 630 for each of the 20 images shown in FIG. 6. In this case, as shown in FIG. 9, the controller 150 deletes only the area 901, 902, . . . , 920 (e.g., the area shown in hatching in FIG. 9) related to the second user who has movement in the second area 630 in the first image to the twentieth image while maintaining the area (e.g., 930 of FIG. 9) irrelevant to the second user (S260).

Thereafter, the controller 150 synthesizes the first areas in the remaining images, where the area related to at least one moving object has been deleted, thereby generating a first replacement image (or first replacement area) corresponding to an image which is in the state where the at least one moving object has been deleted in the first area. Here, the generated first replacement image includes coordinates information corresponding to the first area. Further, the size and shape (or form) of the generated first replacement image corresponds to (or is identical to) the size and shape of the first area. In this case, the controller 150 may perform image correction (or image interpolation) on the first areas in the remaining images.

Further, the controller 150 synthesizes the second areas in the plurality of images, where the area related to at least one moving object has been deleted, thereby generating a second replacement image (or second replacement area) corresponding to an image which is in the state where the at least one moving object has been deleted in the second area. Here, the generated second replacement image includes coordinates information corresponding to the second area. Further, the size and shape (or form) of the generated second replacement image corresponds to (or is identical to) the size and shape of the second area.

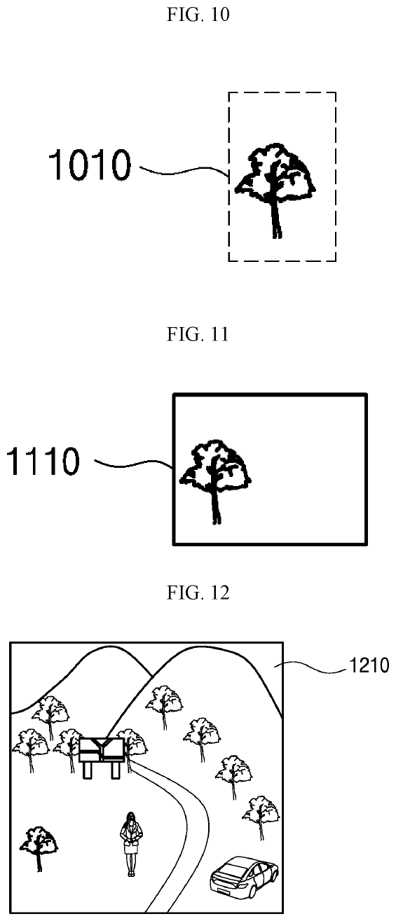

As an example, the controller 150 synthesizes the first areas 510 in the second image to twentieth image, where the area related to the second user has been deleted in the second to twenties images where the area related to the second user who has movement has been deleted as shown in FIG. 8, thereby generating a first replacement image 1010 having the same size and shape as the first area and corresponding to the image in the state of the second user having been deleted in the first area as shown in FIG. 10.

As an example, the controller 150 synthesizes the second areas 630 in the first image to twentieth image, where the area related to the second user has been deleted in the first to twenties images where the area related to the second user who has movement has been deleted as shown in FIG. 9, thereby generating a second replacement image 1110 having the same size and shape as the second area and corresponding to the image in the state of the second user having been deleted in the second area as shown in FIG. 11 (S270).

Thereafter, the controller 150 synthesizes (or adds) the generated first replacement image (or first replacement area) to the deleted first area in the reference image, generating a new image (or completed image). Here, the controller 150 may synthesize the first replacement image to the deleted first area in the reference image based on coordinate information corresponding to the first area included in the generated first replacement image. In this case, the generated new image may be in a state in which at least one moving object has been deleted from the reference image, and the object-deleted area is replaced with the first replacement image.

Further, the controller 150 may delete the second area from the reference image and synthesize (or add) the generated second replacement image (or second replacement area) to the deleted second area in the reference image, generating a new image (or completed image). Here, the controller 150 may synthesize the second replacement image to the deleted second area in the reference image based on coordinate information corresponding to the second area included in the generated second replacement image.

In this case, if an image that does not include the at least one moving object is among the plurality of images, the controller 150 may generate the first replacement image (or second replacement image) based on the first area (or second area) in the image, which does not include at least one moving object, delete the first area (or second area) from the reference image, synthesize (or add) the generated first replacement image (or second replacement image) to the first area (or second area) deleted in the reference image to thereby generate the new image.

As an example, the controller 150 synthesizes the first replacement image 1010 generated in FIG. 10 to the deleted first area 710 in the reference image illustrated in FIG. 7, thereby creating a first new image 1210.

As another example, as illustrated in FIG. 13, the controller 150 deletes (shows in hatching) (1310) the second area including the second user from the reference image, and generates a second new image 1410, as shown in FIG. 14, by synthesizing the second replacement image 1110 generated in FIG. 11 to the second area 1310 deleted in the reference image (S280).

Thereafter, the controller 150 displays the generated new image (or completed image) on the display unit 130.

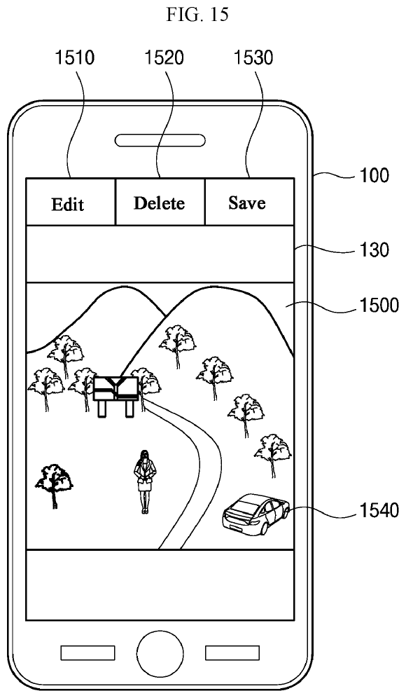

As an example, as illustrated in FIG. 15, the controller 150 displays the generated first new image 1500 on the display unit 130.

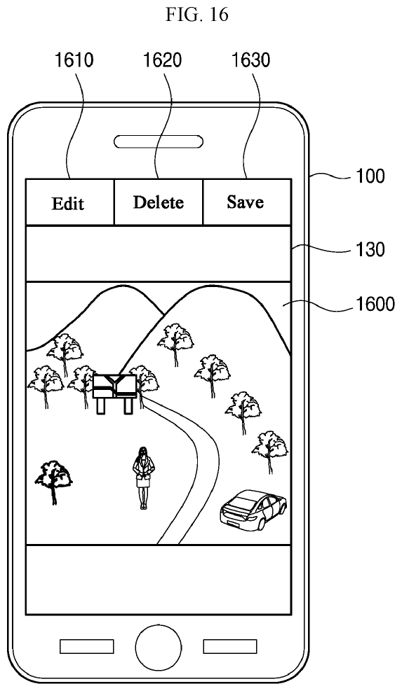

As another example, as illustrated in FIG. 16, the controller 150 displays the generated second new image 1600 on the display unit 130 (S290).

Thereafter, when a preset edit menu (or edit item) displayed on one side of the display unit 130 is selected, the controller 150 performs an editing function on the new image displayed on the display unit 130 according to the user input (or user selection/control).

That is, when the edit menu (or edit item) displayed on one side of the display unit 130 is selected, the controller 150 operates in an edit mode.

Further, if anyone of the objects included in the new image displayed on the display unit 130 is selected according to the user input (or user selection/control), the controller 150 identifies (or sets) a third area (or coordinates) related to the selected object in the new image. Here, the third area related to the selected object may be in the shape of a rectangle, circle, oval, or triangle including the object.

In this case, when a preset event occurs for anyone object (or a plurality of objects) among objects included in the new image displayed on the display unit 130 according to the user input (or user selection/control), the controller 150 may identify the third area related to the selected object in the new image. The event includes, e.g., when a preset delete menu item displayed on the display unit 130 is selected after any one object is selected, when a touch (or selection) on any one object lasts for a preset time, or when the user's touch gesture on the image generation device 100 is sensed for any one object. Here, the user's touch gesture on the image generation device 100 includes a tap, touch & hold, double tap, drag, flick, drag and drop, pinch, and swipe.

The controller 150 deletes the third area related to the identified object in the new image. The controller 150 replaces the deleted third area in the new image with the color of the surroundings of the third area (or the any one object), thereby creating another new image.

The controller 150 deletes the third area related to the any one object in the new image. The controller 150 deletes the area (or sub area) related to the any one object present in the third area identified in the plurality of images. Further, the controller 150 synthesizes the third areas in the plurality of images, where the area related to the any one object has been deleted, thereby generating a third replacement image (or third replacement area) corresponding to an image which is in the state where the any one object has been deleted in the third area. Here, the generated third replacement image includes coordinates information corresponding to the third area. Further, the size and shape of the generated third replacement image may be the same as the size and shape of the third area. Further, the controller 150 synthesizes (or adds) the generated third replacement image (or third replacement area) to the deleted third area in the new image, generating another new image (or another completed image). Here, the controller 150 may synthesize the third replacement image to the deleted third area in the new image based on coordinate information corresponding to the third area included in the generated third replacement image. In this case, the other generated new image may be in a state in which the object selected by the user has been deleted from the new image, and the object-deleted area is replaced with the third replacement image.

The controller 150 deletes the third area related to the any one object in the new image. Further, the controller 150 may generate the other new image by copying and pasting, a specific part of the new image according to the user selection, to the deleted third area in the new image.

The controller 150 deletes the third area related to the any one object in the new image. Further, the controller 150 may create the other new image by pasting another image (or emoticon) according to the user selection to the deleted third area in the new image.

Further, the controller 150 displays a result of performing the edit function (or another new image generated according to the execution of the edit function) on the display unit 130.

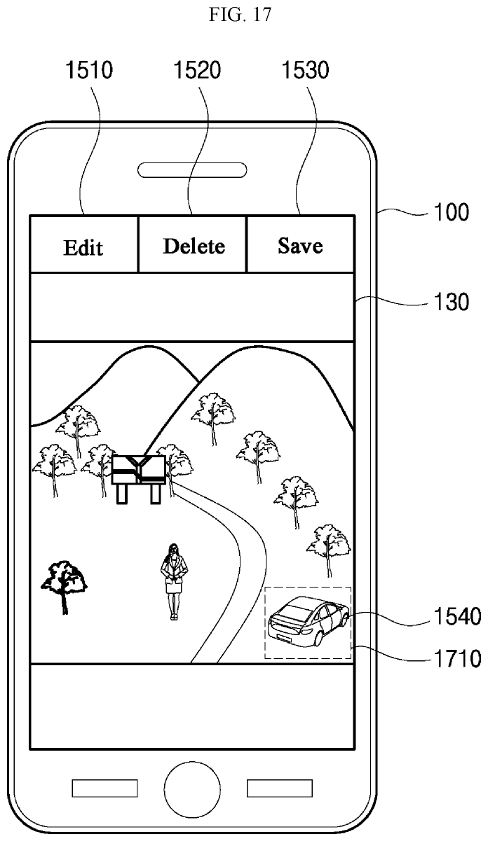

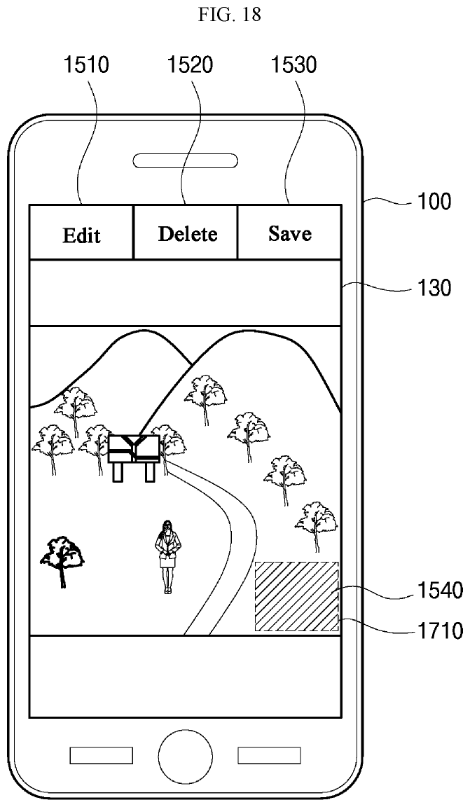

As an example, when the edit menu 1510 displayed on one side of the display unit 130 illustrated in FIG. 15 is selected, the controller 150 operates in an edit mode, and when the vehicle 1540 displayed on the display unit illustrated in FIG. 15 is selected, a third area 1710 related to the selected vehicle 1540 is identified in the first new image 1500, and the outer edge of the third area 1710 related to the vehicle 1540 is indicated by a dotted line as illustrated in FIG. 17.

Further, the controller 150 deletes (shows in hatching) the third area 1710 related to the selected vehicle 1540 from the first new image 1500 as illustrated in FIG. 18.

Further, the controller 150 deletes the third area related to the vehicle for each of the first to twentieth images related to the first new image.

Further, the controller 150 synthesizes the third areas in the first to twentieth images, where the third area related to the vehicle has been deleted, thereby generating a third replacement image (or third replacement area) corresponding to an image which is in the state where the vehicle has been deleted in the third area.

Further, the controller 150 generates a third new image by synthesizing the generated third replacement image to the deleted third area in the first new image.

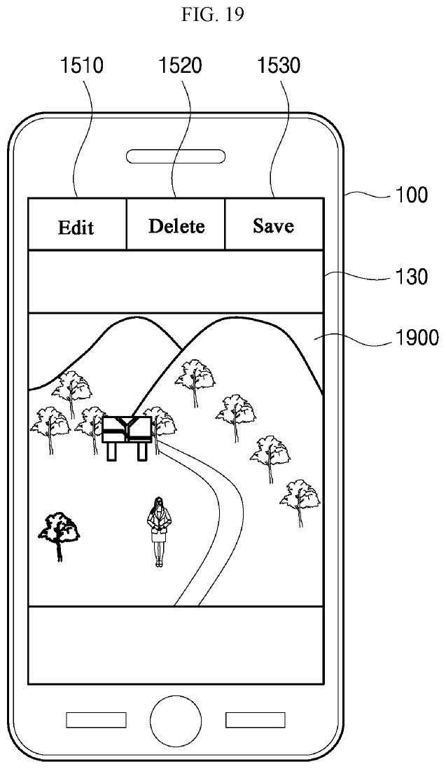

As illustrated in FIG. 19, the controller 150 displays the generated third new image 1900 on the display unit 130 (S300).

As described above, the embodiments of the present invention automatically identifies and removes a moving object from a plurality of consecutive images including one or more objects captured in the same location, thereby generating an image including only the desired object whose movement is maintained. Therefore, even when an image is captured in a crowded place, an image including only a desired object may be acquired, thereby increasing the user's interest.

1. An image generation device, comprising:
a camera unit obtaining a plurality of original images;
a controller generating a plurality of images which are copied images of the plurality of original images obtained by the camera unit, recognizing one or more objects included in the plurality of images, identifying coordinates and distances between objects recognized in each of the plurality of images, identifying at least one object without movement and at least one object with movement among the objects included in the images by identifying the coordinates and distances between the objects in two consecutive images of the plurality of images, identifying a first area related to the at least one object with movement in a reference image, deleting the first area related to the at least one object with movement identified in the reference image, deleting an area related to the at least one object with movement present in the first area in remaining images except for the reference image among the plurality of images, generating a first replacement image corresponding to an image, in which the at least one object with movement is deleted in the first area, by synthesizing the first area in the remaining images in which the area related to the at least one object with movement is deleted, and generating a new image by synthesizing the generated first replacement image to the deleted first image in the reference image; and
a display unit displaying the generated new image.

2. The image generation device of claim 1, wherein the first replacement image includes coordinate information corresponding to the first area, and wherein a size and shape of the first replacement image correspond to a size and shape of the first area.

3. The image generation device of claim 1, wherein the controller generates the new image by synthesizing the first replacement image to the deleted first area in the reference image based on coordinate information corresponding to the first area included in the first replacement image.

4. The image generation device of claim 1, wherein the controller identifies a second area related to the at least one object with movement for the plurality of images, deletes an area related to the at least one object with movement present in the identified second area in the plurality of images, generates a second replacement image corresponding to the image, in which the at least one object with movement is deleted in the second area by synthesizing the second area in the plurality of images where the area related to the at least one object with movement is deleted, deletes the second area in a reference image, and generates the new image by synthesizing the generated second replacement image to the deleted second area in the reference image.

5. An image generation method, comprising:
obtaining a plurality of original images by a camera unit;
generating, by a controller, a plurality of images which are copied images of the plurality of original images obtained by the camera unit;
recognizing, by the controller, each of one or more objects included in the plurality of images;
identifying, by the controller, coordinates and distances between objects recognized in each of the plurality of images;
identifying, by the controller, at least one object without movement and at least one object with movement among the objects included in the images by identifying the coordinates and distances between the objects in two consecutive images of the plurality of images;
identifying, by the controller, a second area related to the at least one object with movement for the plurality of images;
deleting, by the controller, an area related to the at least one object with movement present in the identified second area in the plurality of images;
generating, by the controller, a second replacement image corresponding to an image in which the at least one object with movement is deleted in the second area by synthesizing the second area in the plurality of images, in which the area related to the at least one object with movement is deleted;
generating, by the controller, a new image by deleting the second area in the reference image and synthesizing the generated second replacement image to the deleted second area in the reference image; and
controlling, by the controller, a display unit to display the generated new image.

6. The image generation method of claim 5, further comprising:
identifying, by the controller, a first area related to the at least one object with movement in the reference image;
deleting, by the controller, the first area related to the at least one object with movement identified in the reference image and deleting an area related to the at least one object with movement present in the first area in remaining images except for the reference image among the plurality of images;
generating, by the controller, a first replacement image corresponding to an image in which the at least one object with movement is deleted in the first area by synthesizing the first area in the remaining images, in which the area related to the at least one object with movement is deleted; and
generating, by the controller, the new image by synthesizing the generated first replacement image to the deleted first area in the reference image.

7. The image generation method of claim 5, further comprising:
performing an edit function on the new image displayed on the display unit according to a user input, by the controller, when a preset edit menu displayed on a side of the display unit is selected; and
displaying a result of performing the edit function by the display unit.

8. The image generation method of claim 7, wherein performing the edit function on the new image includes at least one of:
when any one of objects included in the new image displayed on the display unit is selected, identifying, by the controller, a third area related to the selected object in the new image;
deleting, by the controller, the third area related to the identified object in the new image;
generating, by the controller, another new image by replacing the third area in the new image, in which the third area is deleted, with a surrounding color of the third area;
generating, by the controller, the other new image by deleting an area related to the any one object present in the identified third area in the plurality of images, for the plurality of images, synthesizing the third area in the plurality of images in which the area related to the any one object is deleted to thereby generate a third replacement image corresponding to the image in which the any one object is deleted in the third area, and synthesizing the generated third replacement image to the deleted third area in the new image;
generating, by the controller, the other new image by copying and pasting a specific part of the new image according to a user selection, to the deleted third area in the new image; and
generating, by the controller, the other new image by pasting another image according to a user selection to the deleted third area in the new image.
